(19) United States
(12) Patent Application Publication
(10) Pub. No.: US 2018/0039971 A1
(43) Pub. Date: Feb. 8, 2018

(54) Snap It Go System and Method

(71) Applicant: Ben Mansur, Queen Creek, AZ (US)

(72) Inventor: Ben Mansur, Queen Creek, AZ (US)

(21) Appl. No.: 15/668,597

(22) Filed: Aug. 3, 2017

Related U.S. Application Data
(60) Provisional application No. 62/371,058, filed on Aug. 4, 2016.

(51) Int. Cl. G06Q 20/28; G06K 7/10; G06K 7/14

(52) U.S. Cl. CPC G06Q 20/28; G06K 7/1413; G06K 7/1417; G06K 7/10297

(57) ABSTRACT

A system and method to allow the virtual equivalent tendering of cash using a push model, so that a user may pay a transaction through an electronic prepaid, credit and/or debit accounts' mechanism, when paying for goods and services. In effect, the system replicates the tendering of a cash transaction (through a push rather than a pull model), providing vendors and customers with an easy to interface approach.

### CROSS-REFERENCE TO RELATED APPLICATIONS

This application claims priority to co-pending U.S. Provisional patent application Ser. No. 62/371,058 titled “Repay2Me”, filed on Aug. 4, 2016 the disclosure of which is herein incorporated by reference in its entirety.

### PATENTS CITED

The following documents and references are incorporated by reference in their entirety, Karns et al (U.S. Pat. No. 7,370,012), Calman et al (U.S. Pat. Pub. No. 2014/0278989), New et al (U.S. Pat. No. 8,867,713), Noe et al (U.S. Pat. Pub. No. 2015/0206110), Paschini et al (U.S. Pat. No. 9,558,484), Resnick et al (U.S. Pat. No. 8,086,530), Paschini et al (U.S. Pat. No. 8,967,464), Templeton (U.S. Pat. Pub. No. 20110029434), Brunet et al (U.S. Pat. Pub. No. 20070271192) and Fournier et al (U.S. Pat. Pub. No. US20110066513).

### FIELD OF THE INVENTION

The present invention relates to a system and method for the payment of financial transactions through electronic prepaid, credit and debit accounts' mechanisms that may be used at any participating location for paying for goods and services. In particular to a system and method that utilizes auto-ID technology to replicate the traditional action of tendering of a cash for a payment transaction through a push rather than a pull model, providing vendors and customers with an easy to interface approach.

### DESCRIPTION OF THE RELATED ART

There are presently many credit and debit card options available. However, most of them require some form of identification, as well as the establishment of personal bona fides. Similarly, many phones use near RF and/or barcode technology (and other similar non-contact RF/RFID technologies) to identify the ‘device possessor’ as the ‘owner’ of the credit/debit card or device.

However, in general, the payment transaction is one where the vendor informs the user of the transaction total through some form of electronic pull (typically their Point of Sale (POS) system informs your device (more and more the cellphone/smartphone that belongs to the user). In effect, the traditional transaction of “It's $4.50” (spouted by the vendor), followed by you giving them the amount, has being replaced by an overly complicated model where multiple communication channels are required.

Finally, the fragmentation of loyalty and frequent purchase programs has created an existence where most individuals are hard pressed to remember a multitude of accounts and rewards.

What is required, is a way to bring the Credit/Debit card benefits to everyone, without the necessary attachment to a physical device, and preferably to do so in a single program model that allows you to “push” the payment to the vendor.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect, the invention is about an electronic prepaid system and/or method that can be used at any participating location for paying for goods and services, said system comprising one or more Auto ID enabled vendor identification components, one or more client devices having user interface display components, Auto ID scanning components and communication capabilities components, one or more Snap It Go (SIGO) servers capable of communicating with said one or more of client devices as well as one or more merchant devices and/or merchant servers and one or more vendor devices capable of receiving confirmations from either said SIGO servers and/or said merchant servers and showing the SIGO approved transaction to said vendors. In another aspect, said one or more Auto ID enabled vendor identification component is comprised of one or more from the list consisting of: 1-D barcodes, 2-D barcodes, NFC components and/or RFID chips, said one or more user interface component is comprised of one or more from the list consisting of: mobile Smartphone, electronic watch, tablet, laptop or similar mobile computing platform and/or fixed computing platform, said Auto ID scanning component is comprised of one or more from the list consisting of: barcode scanner, imager scanner, NFC scanner and/or RFID scanner, said communication capabilities component is comprised of one or more from the list consisting of: wired or wireless Internet/Ethernet, Wi-Fi and/or 3G/4G/LTE/5G or similar wireless protocol and said one or more vendor devices capable of receiving confirmations from either said SIGO servers and/or said merchant servers and showing the SIGO approved transaction to said vendor is comprised of one or more from the list consisting of: color light indicating approval of payment, mobile Smartphone, electronic watch, tablet, laptop, similar mobile computing platform and/or fixed computing platform.

In one aspect, the invention is a non-transitory computer-readable medium embodying a program executable in at least one computing device, the program, when executed, causing at least one said computing device to execute a risk-sharing mechanism comprising, one or more Auto ID enabled vendor identification components, one or more client devices having user interface display components, Auto ID scanning components and communication capabilities components, one or more Snap It Go (SIGO) servers capable of communicating with said one or more of client devices as well as one or more merchant devices and/or merchant servers and one or more vendor devices capable of receiving confirmations from either said SIGO servers and/or said merchant servers and showing the SIGO approved transaction to said vendors. In another aspect, said one or more Auto ID enabled vendor identification component is comprised of one or more from the list consisting of: 1-D barcodes, 2-D barcodes, NFC components and/or RFID chips, said one or more user interface component is comprised of one or more from the list consisting of: mobile Smartphone, electronic watch, tablet, laptop or similar mobile computing platform and/or fixed computing platform, said Auto ID scanning component is comprised of one or more from the list consisting of: barcode scanner, imager scanner, NFC scanner and/or RFID scanner, said communication capabilities component is comprised of one or more from the list consisting of: wired or wireless Internet/Ethernet, Wi-Fi and/or 3G/4G/LTE/5G or similar wireless protocol and said one or more vendor devices capable of receiving confirmations from either said SIGO servers and/or said merchant servers and showing the SIGO approved transaction to said vendor is comprised of one or more from the list consisting of: color light indicating approval of payment, mobile Smartphone, electronic watch, tablet, laptop, similar mobile computing platform and/or fixed computing platform.

Other features and advantages of the present invention will become apparent upon examining the following detailed description of an embodiment thereof, taken in conjunction with the attached drawings.

### BRIEF DESCRIPTION OF THE DRAWINGS

FIG. 1 shows an illustration of the system architecture and critical components of the “Snap It Go” system, according to an exemplary embodiment of the invention.

FIG. 2 shows a proposed “Snap It Go” application splash screen, according to an exemplary embodiment of the invention.

FIGS. 3 and 4 show proposed “Snap It Go” application welcome screens, according to an exemplary embodiment of the invention.

FIG. 5 shows a proposed “Snap It Go” application password screen, according to an exemplary embodiment of the invention.

FIG. 6 shows a proposed “Snap It Go” application status screen, according to an exemplary embodiment of the invention.

FIG. 7 shows a proposed “Snap It Go” application menu screen, according to an exemplary embodiment of the invention.

FIG. 8 shows a proposed “Snap It Go” application choice selection screen, according to an exemplary embodiment of the invention.

FIG. 9 shows a proposed “Snap It Go” initial credit card validation screen, according to an exemplary embodiment of the invention.

FIG. 10 shows a proposed “Snap It Go” application payment method selection screen, according to an exemplary embodiment of the invention.

FIG. 11 shows a proposed “Snap It Go” application Receipt/Review transaction screen, according to an exemplary embodiment of the invention.

FIG. 12 shows a proposed “Snap It Go” PIN/Password change screen, according to an exemplary embodiment of the invention.

FIG. 13 shows a proposed “Snap It Go” multi profile screen, according to an exemplary embodiment of the invention.

FIG. 14 shows a proposed “Snap It Go” alternate ID/additional verification instruction screen, according to an exemplary embodiment of the invention.

FIG. 15 shows a proposed “Snap It Go” Holder Name and Billing Address information screen, according to an exemplary embodiment of the invention.

FIG. 16 shows a proposed “Snap It Go” Credit Card Info/selection screen, according to an exemplary embodiment of the invention.

FIG. 17 shows a proposed “Snap It Go” Credit Card entering and nickname screen, according to an exemplary embodiment of the invention.

FIG. 18 shows a proposed “Snap It Go” payment+gratuity payment screen, according to an exemplary embodiment of the invention.

FIG. 19 shows a proposed “Snap It Go” payment and status screen, according to an exemplary embodiment of the invention.

FIG. 20 shows a proposed “Snap It Go” balance and discount available screen, according to an exemplary embodiment of the invention.

FIGS. 21-23 show proposed “Snap It Go” automated gratuity calculating screens, according to an exemplary embodiment of the invention.

FIG. 24 shows a proposed “Snap It Go” support screen, according to an exemplary embodiment of the invention.

FIG. 25 shows a proposed “Snap It Go” user address information screen, according to an exemplary embodiment of the invention.

FIG. 26 shows a proposed “Snap It Go” Credit Card options screen, according to an exemplary embodiment of the invention.

FIG. 27 shows a proposed “Snap It Go” receipt screen, according to an exemplary embodiment of the invention.

FIG. 28 shows a proposed “Snap It Go” 2-D barcode sign and/or application screen, according to an exemplary embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

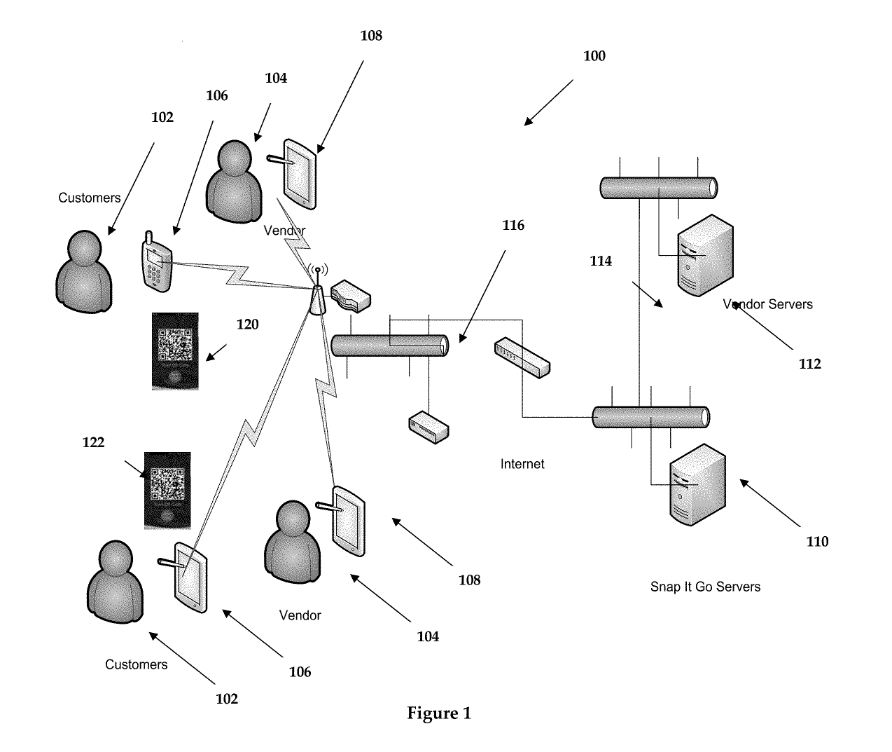

Referring to FIG. 1, we see an architectural level detail of the Snap It Go (SnItGO or SIGO) 100 system. SIGO consists of an electronic prepaid, credit and debit accounts' system that can be used at any participating location for paying for goods and services. While using it, users (that is, both customers 102 and vendors 104) interact with the SIGO system through one or more client devices 106/108 (each which may be a mobile Smartphone, electronic watch, tablet, laptop or similar mobile computing platform and/or fixed computing platforms), each device having suitable user interface display, data entry/selection (including the optional ability to scan 1-D/2-D barcodes and/or Near Field Communication (NFC)/RFID as well as wired/wireless communication capabilities) to one or more servers (both SIGO servers 110 and Vendor servers 112) executing the system software enabling the SIGO system to operate. The SIGO 110 and Vendor servers 112, are capable of communicating with each other through the internet cloud 114/116, so that the linking to said one or more client/customer devices 106 as well as with one or more merchant devices (which may include Point of Sale (POS) 108, merchant servers 112 and/or merchant mobile devices 108 similar to the clients). This communication may be accomplished with one or more of suitable communication capabilities, such as wired or wireless Internet/Ethernet, Wi-Fi, Bluetooth or similar, 3G/4G/LTE/5G or similar wireless protocols.

Thus, when we speak of the user accounts, we refer to the interaction of one or more applications in one or more of said mobile/fixes devices used by users 106, the SIGO servers 110 as well as those computers operated by merchants 108/112. The user begins by establishing a user's account, which may be funded in a number of ways. These include separate credit card, debit card, ACH or check accounts, as well as direct deposit, indirect deposit, transfers (e.g. MONEYGRAM, WESTERN UNION, PAYPAL, XOOM, etc.).

In effect, you create an SIGO user account that may be funded with any currency (and from anywhere in the world), including electronic currencies such as BITCOIN or other similar electronic currency systems. Currency conversions will be performed by Snap It Go from the user's account profile currency to the accepted merchant currency. Users can change their accounts currency profile and an interchange rate will be applied by Snap It Go. Transfer of funds between users will be available in the form of non-refundable gifted funds.

Of course, to avoid scams and/or illegal activities, all registered funding accounts will go through a validation process; and credit and debit cards will go through a pre-authorization process where the credit card processor(s) for the primary account number and address verification, including the credit card “Card Verification Value” (CVV) and/or Card Security Code (CSC) codes must match the account in order to store the information and make the account readily available to use for a limited amount of funds until a physical verification process has been applied physical for application of debit cards and credit cards will be performing participating locations.

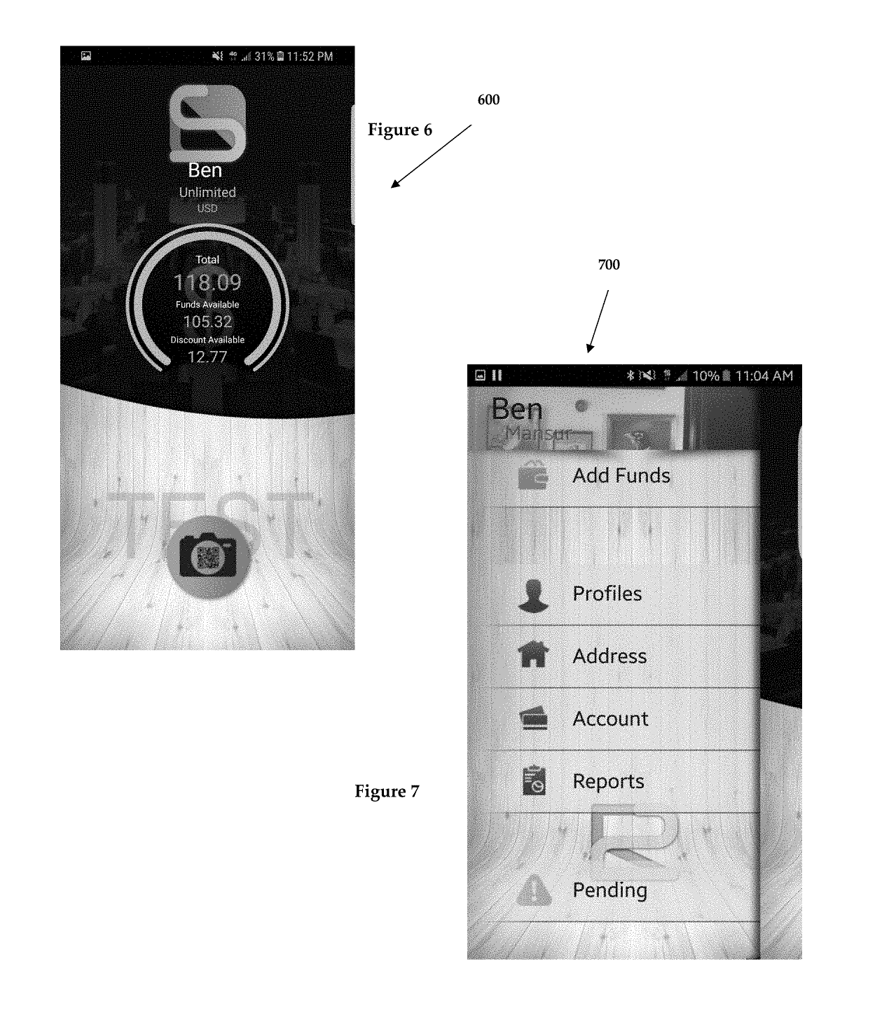

An account holder's ID (as well as the physical card) are required to proceed handy applications under the accounts SIGO page. In this form, users of all accounts requiring verification (or match a specific user′) need to select an account and press the validation bottom displaying the activation screen. In such a fashion, user's press independent activation screens when they press activation which generates indicia (preferably machine readable) such as QR code FIG. 7 (or other suitable 1-D, 2-D barcodes, OCR codes, etc.).

In one embodiment the system is simple to use. A merchant presents the customer with a bill (say in a verbal fashion “It's $17 dollars”), or written on a piece of paper, or a board. In this, the system replicates the traditional ‘lunch counter’ billing, not requiring any electronics by the merchant. The food truck, or the table, or even the server's ID Badge and/or any wall/surface nearby, has an auto ID enabled vendor identification component. This ID enabled vendor identification component may be comprised of a 2-D barcode sign 120 or an RFID/NFC sign, tag or similar. This sign includes the information about the establishment and their SIGO account, as well as specific server/location/table information. Note, that in this embodiment, there is no specific information about the transaction. In this fashion the Auto ID sign (1-D/2-D/NFC/RFID enabled sign is ‘reusable’. That is, the same sign may be used over and over.

The user then proceeds to pay what was ‘presented’ by the server (say the $17 plus a $4 tip, total of $21), by activating their SIGO unit 106, and directing it to pay $21 to the information scanned from the Auto ID sign 120 (Say reading the 2-D DataMatrix or QR Code). The amount is transferred from the SIGO server 110 to the vendor server 112 and confirmed to the server via either a message from the vendor servers 112 to the vendor POS/device 108 (i.e. using SMS texting, WhatsApp, Facebook Messenger), or from the SIGO vendor 110 to the vendor 108 devices through similar validated internet channels 114/116. In an even simpler mode, a communication enabled color light indicating approval of payment (e.g. Red/Green light on the customer's table), may change colors to indicate their payment has been accepted.

In an alternate embodiment, the 2-D sign 120 includes a unique ID for the transaction (say generated within the receipt and/or through an image of a machine readable code (1-D barcode, 2-D barcode, Optical Character Recognition (OCR), even a unique number sent to the client via SMS, via a short range Bluetooth or similar wireless connection or even entered by the user). Upon presentation of the code, the user accepts the charges represented by the unique transaction (by being accepted by the by the SIGO application within the user's device), which then (the user having performed all validations on their device) proceeds to approve the charges and deducts them from the user's account.

In one embodiment, an optional PDF or an image of the actual receipt can be uploaded with the transaction. The user can download these transactions and submit for business reports or tax reports.

The device used by the user (whether a mobile Smartphone, electronic watch, tablet, laptop or similar mobile computing platform and/or fixed computing platform) when activating the system will send a request (over any suitable communication link such as wired or wireless Internet/Ethernet, Wi-Fi or similar, 3G/4G/LTE/5G or similar wireless protocol) which will then be routed by the cloud to one of the SIGO servers with the particular user's account information to be retrieved along with a token presented to the users device screen as a QR code, the merchant will then proceed with scanning the QR code (using their Point of Sale (POS), scanners or even their Smartphone), sending the information to the SIGO server and requesting the account holder information in the account itself.

In one embodiment, this account information is displayed on the merchant's device screen, at which time the merchant asks the user for a valid government issued ID matching the information that the SIGO system provided and the physical card matching the card information that the SIGO system provided. In some markets, a user may then be required to enter the appropriate Card Verification Value (CVV), Card Security Code (CSC) or private PIN associated with the account in order to validate that they physically have the card on hand. If the CVV, CSC or PIN code do match our records than the account is moved to activated and there are no more restrictions on this account.

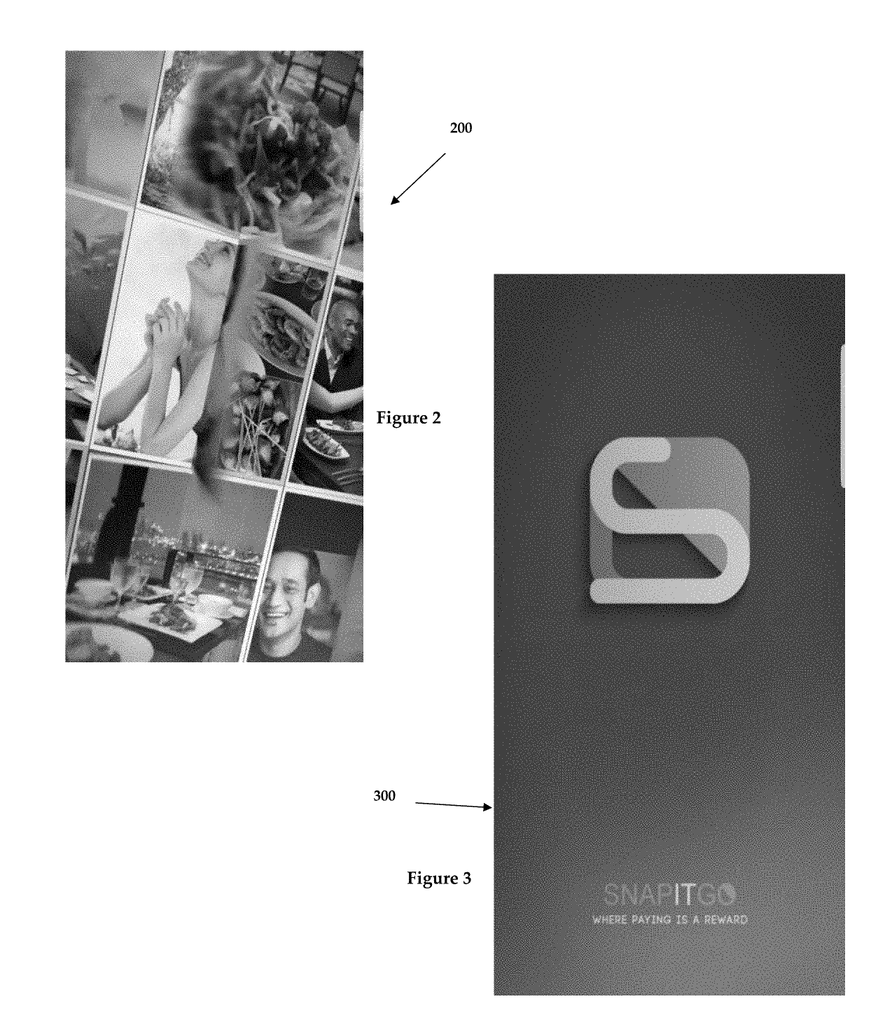

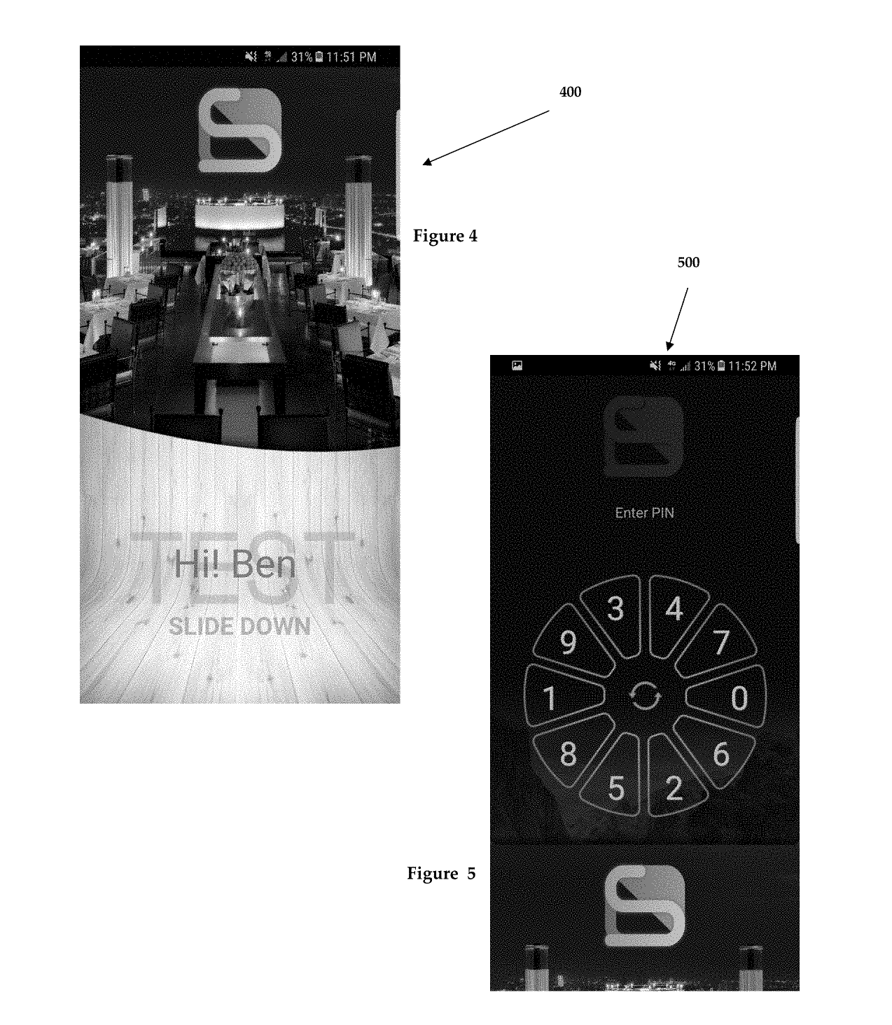

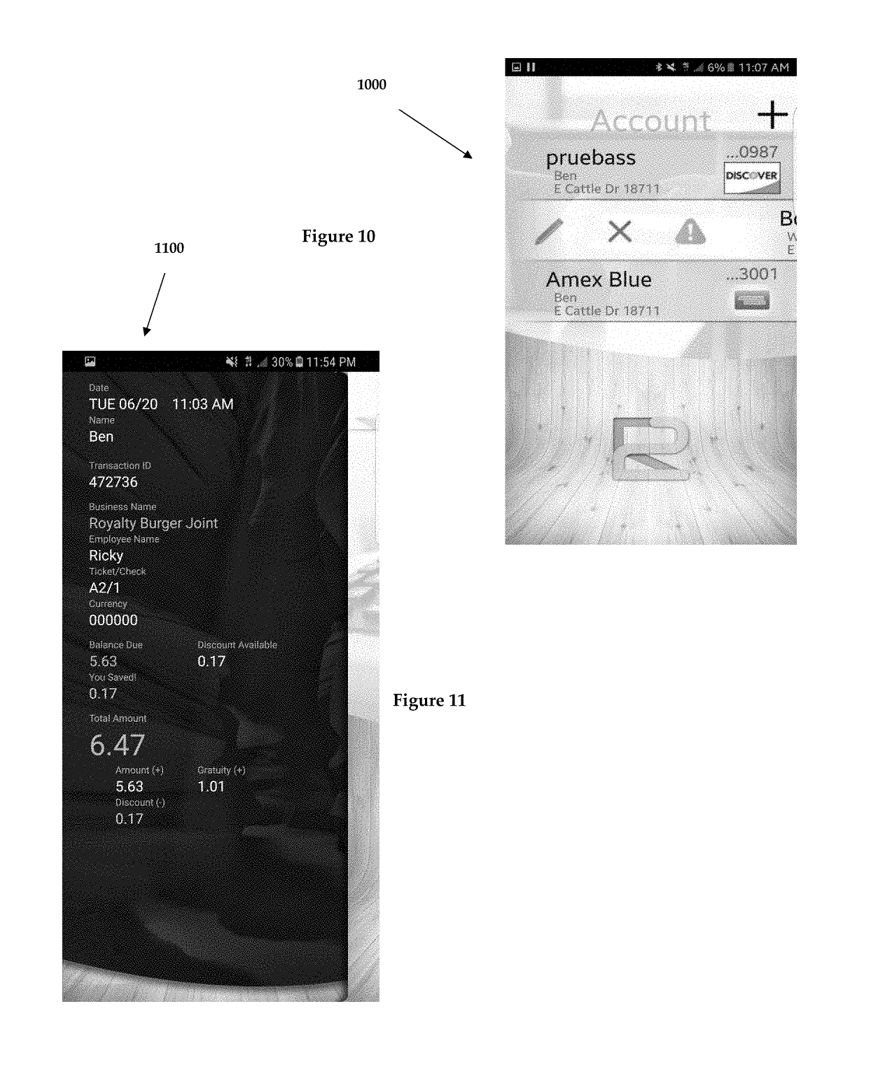

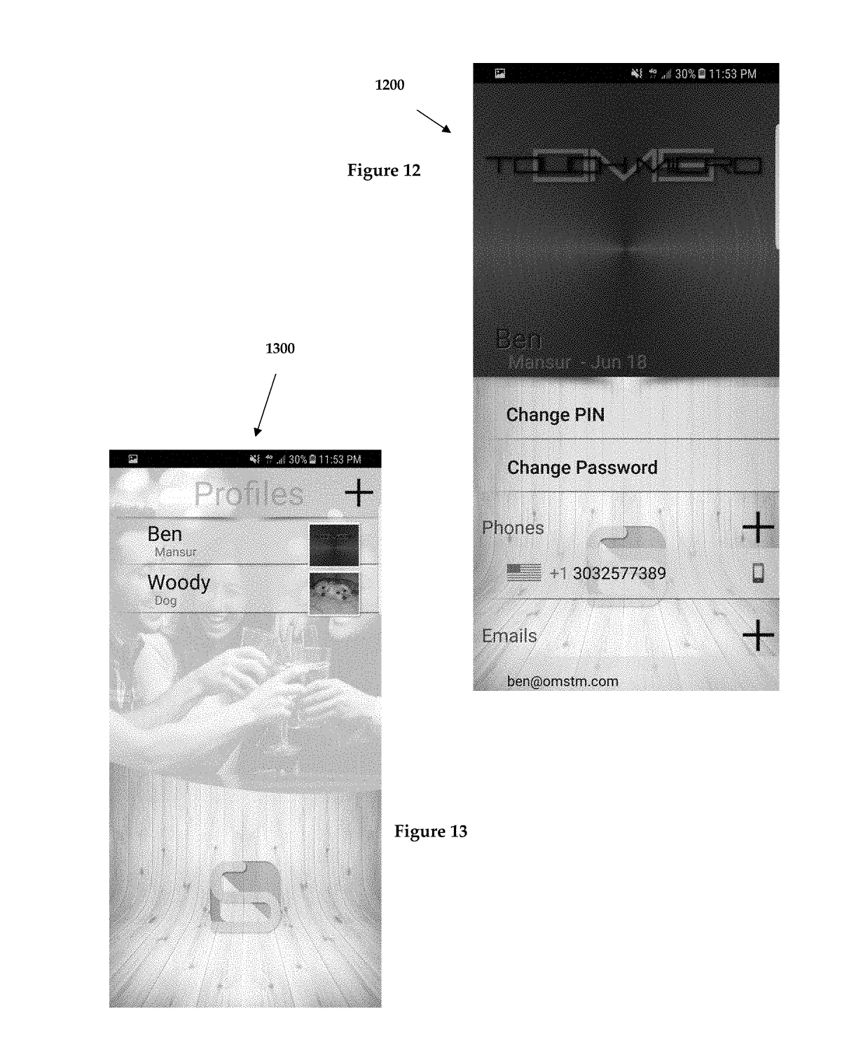

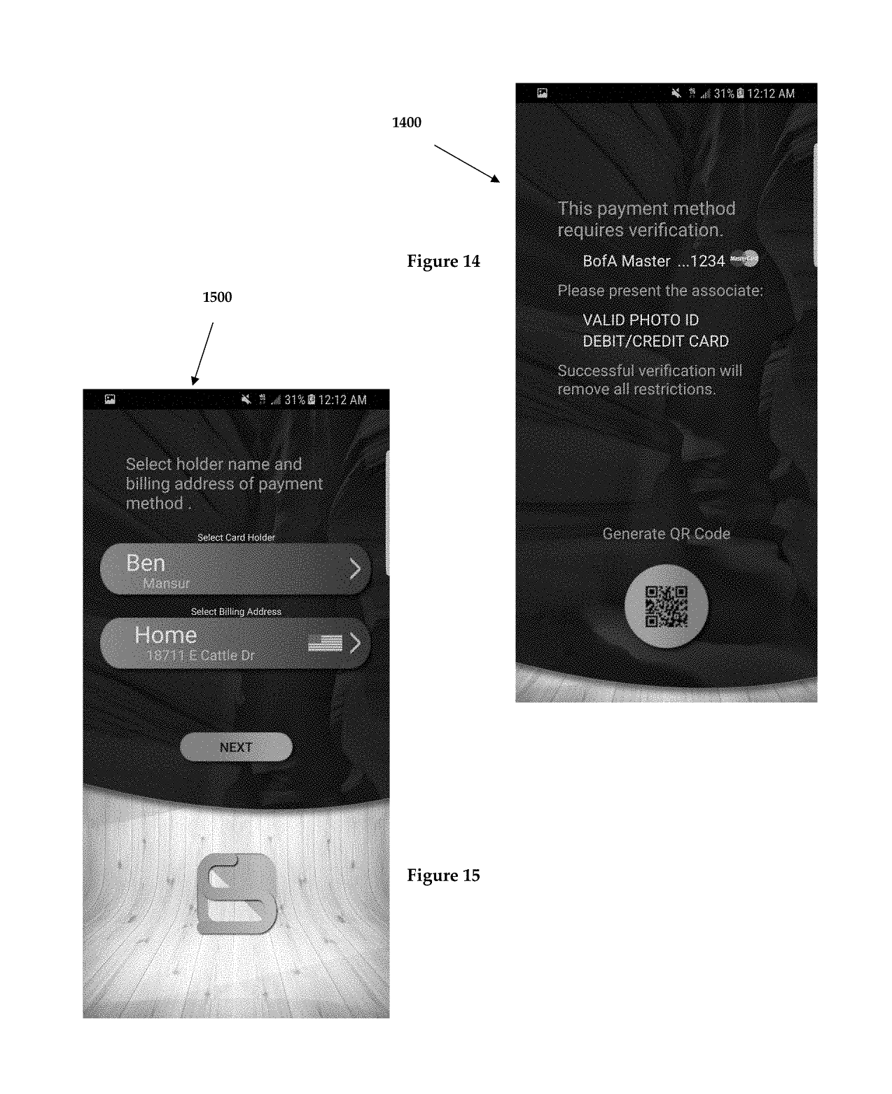

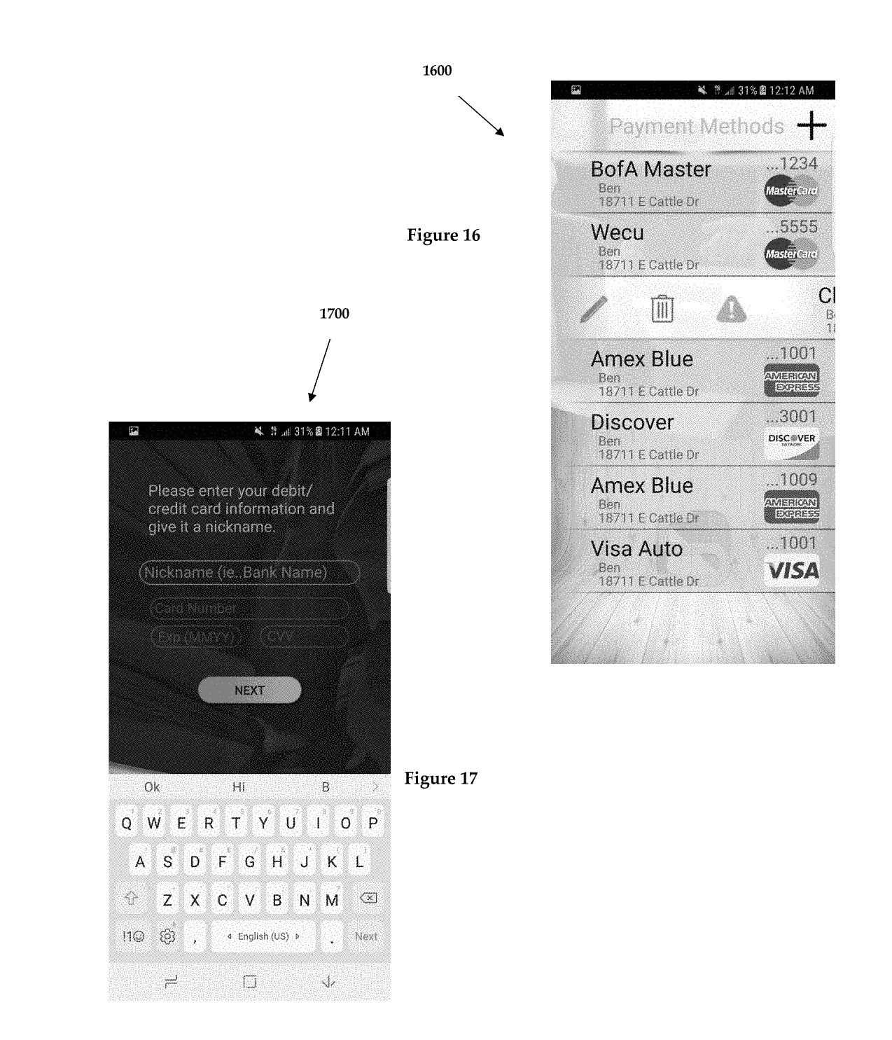

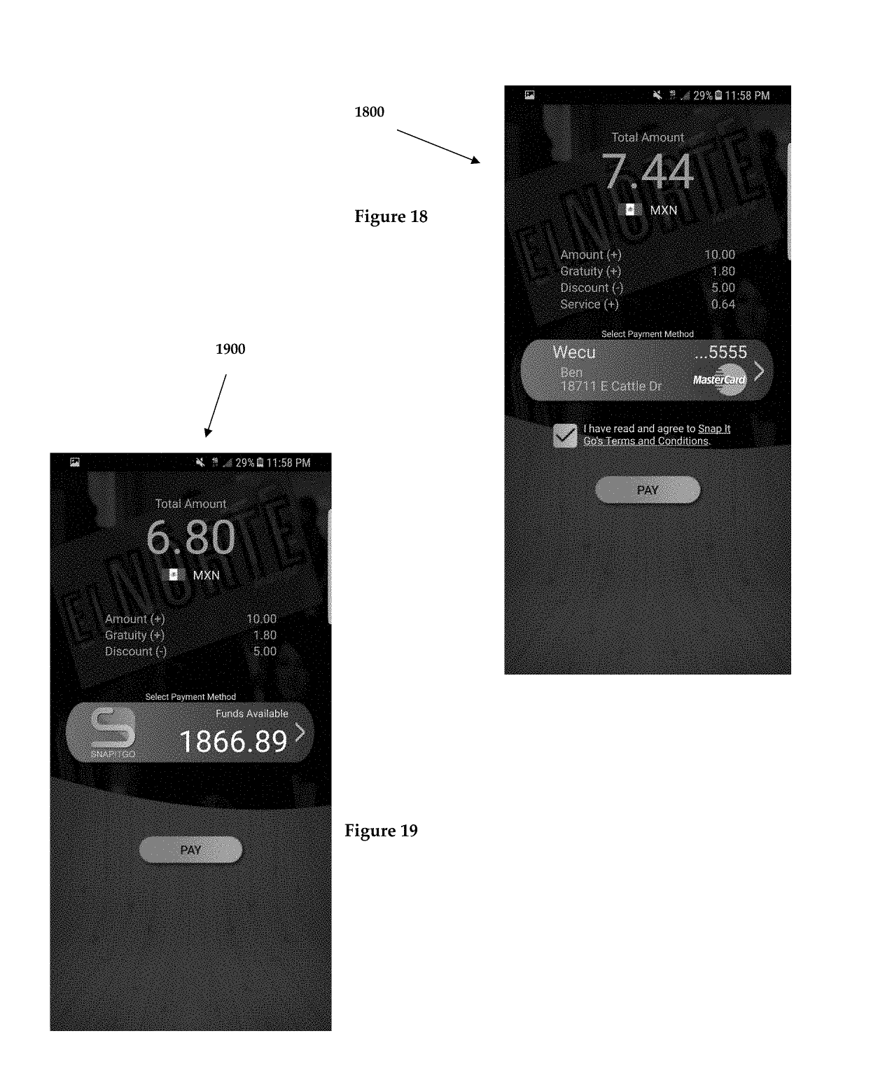

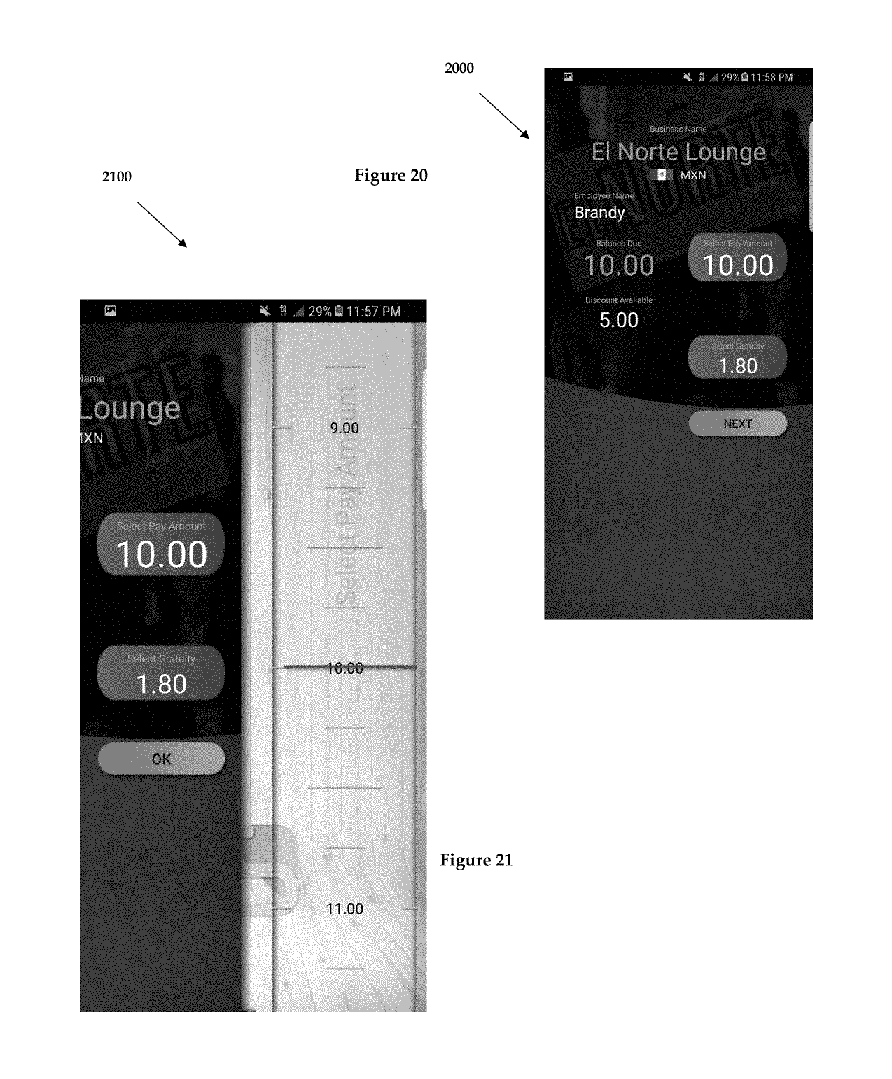

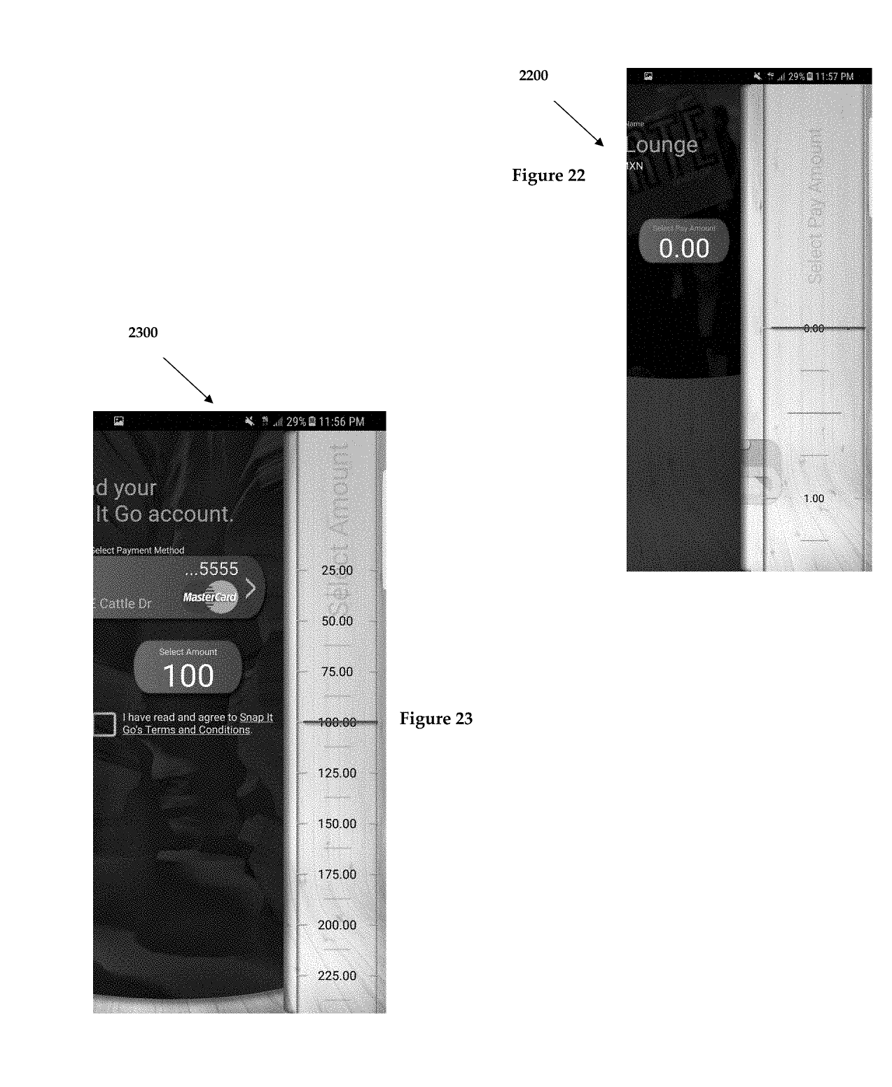

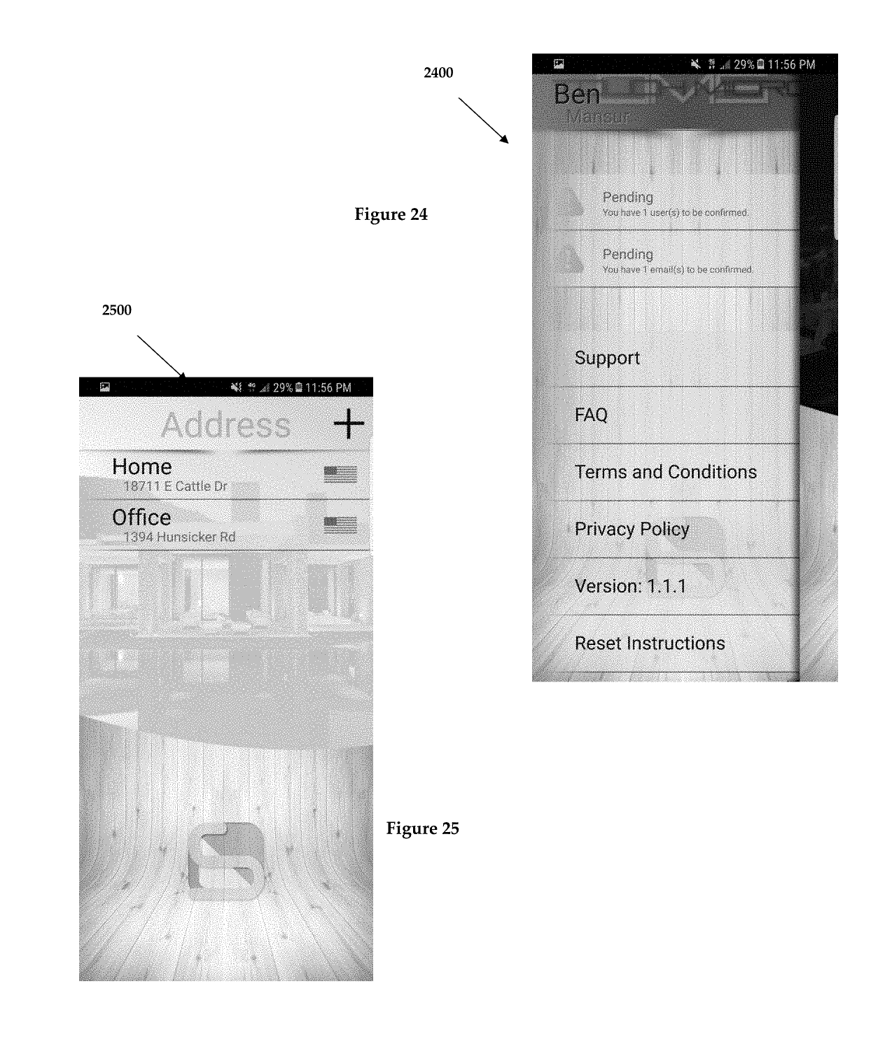

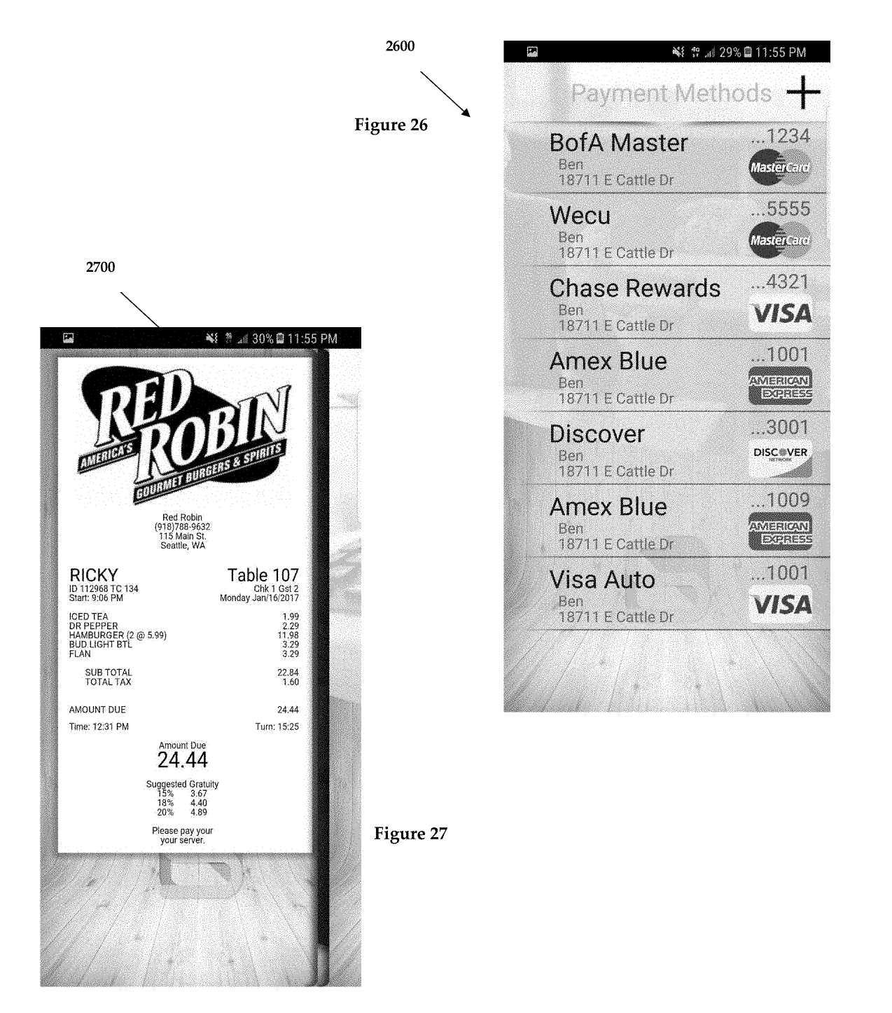

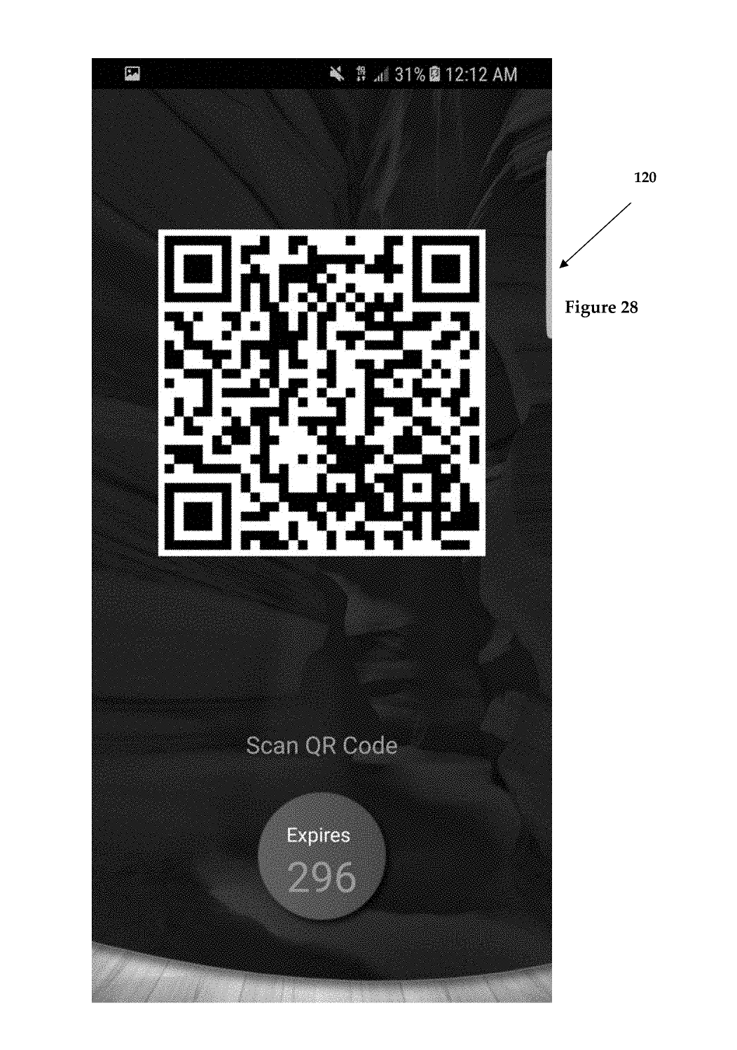

Referring to FIGS. 2-27, we see in FIGS. 2-3 the mobile app 200/300 video collage which will include various animations, the one that we are using currently is a collage or locations and users and entrees and services, as of creating a representation of a community. FIG. 4 shows 400 and embodiment where the mobile app will downloading various images of the other Merchants locations images that have been uploaded by users more chance to promote businesses or services or a scenario. FIG. 5 shows the mobile app passcode page 500, where in one embodiment the user enters a 6-digit passcode through a circular randomized keypad, so that the digits are transmitted using a tokenized system, in which the tokens are created on a server, that way the passcode is always protected and it's always unique during transmission over the internet.

FIG. 6 shows a conceptual type of a splash screen 600 where the user will be given an array of discounts, promotions and events that are happening around them via the device is reporting IP or GPS location, the promotions will be personalized to the user's history and the merchant selection of participating discounts and promotions that are determined through the setup under the merchant's ID user interface. FIG. 7 illustrates a mobile app main screen 700, here the users will be able to access the submenus and the main payment tools. In one embodiment, we would display the clients current value of discount and funds and additional information pertaining to his/her account with the animated visual representation of those funds in amounts available.

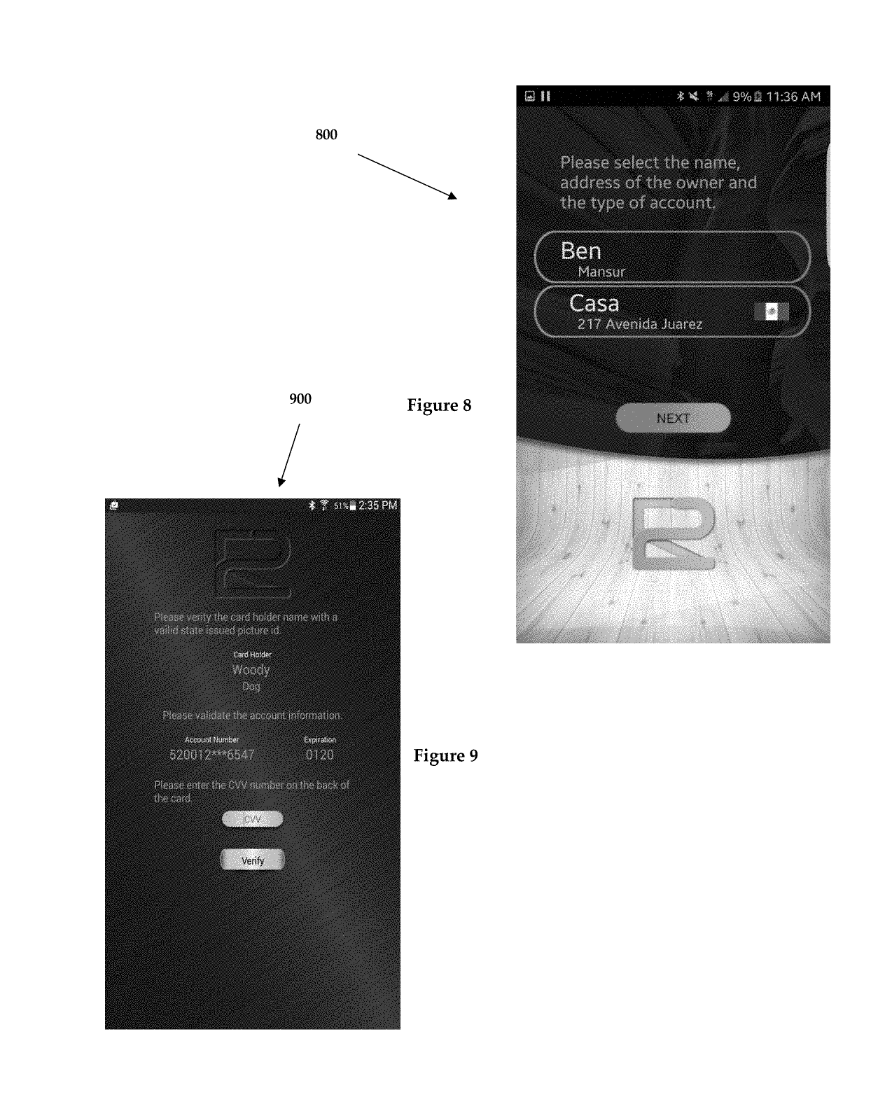

FIG. 8 shows a screen 800 that is accessible from the main screen, which acts as the main payment tool, in which a 2-D barcode image, in this case a QR code or barcode reader app. On scanning the barcode, the reader will go ahead and access the server through a tokenize system, finding the barcode information downloading the transaction that was previously stored there by the merchant application upon reviewing the information and validating through tokenization and session tokens. the transaction is downloaded and displayed to the customer.

The customer will then be able to see what the transaction is for through name of the business, amounts any additional tools that the merchant has had as such as a gratuity comps and discounts and emerging as the main and the user. at this particular point we'll be able to address any payment amount gratuity amount and submitted for final payment. The barcodes are QR codes presented to this particular tool can be either in an analog printed on paper or through a digital displayed on a screen. GPS location for both the merchants and the user ID for validating and more security making sure that the user is at the merchant's location and that the merchant that is actually where the user is at.

FIGS. 9-27 show proposed “Snap It Go” application choice selection screen 900, initial credit card validation screen 1000, application payment method selection screen 1100 credit card information entry screen 1200. In addition, you can see a multi profile screen 1300, alternate ID/additional verification instructions 1400, SIGO holder Name and Billing Address information 1500 as well as Credit Card Info/selection screen 1600. User's may enter Credit Card entering and nicknames 1700, payment+gratuity details 1800 and/or payment and status 1900, balance and discount available 2000, automated gratuity calculating screens 2100/2200/2300, as well as other support screens 2400. Including user address information 2500 screen, Credit Card options 2600 and receipts 2700.

If the user device cannot scan the merchant transaction QR code, a secondary backup payment is activated. The user device will request a QR token from the SIGO server. The SIGO server will validate the user through a tokenization system. The token has a short life cycle. Upon validation a QR token is sent back to the user device. The generated QR code is presented to the merchant. The merchant scans the QR code sending it to the SIGO server ensuring that the QR code is within the life cycle and that the user is valid and if tokens are correct the transaction is then downloaded by the user device and the user then has the ability to look at the transaction validated that the merchant is the correct merchant, the amounts are correct. At this point he can go ahead and adjust the transaction through the added tools, gratuity, discounts and submit the transaction for final payment. Through GPS and IP validation on both the merchants and the user devices to assure that the merchant is the correct Merchant and that the user is at the correct location to prevent fraudulent transactions. FIGS. 8-11 illustrate other display screens.

There are a number of SIGO credit card fees payment options. These include; a prepaid payment option where the user or customer will use a prepaid account set up in the Snap It Go system (through one or more applications) on their device (i.e. smart phones, tablet, etc.) to purchase goods and services at participating locations. Snap It Go charges corresponding credit card fees plus an additional administrative fee to users when loading funds in the application, however this charge will be offset by possible discounts, free goods, and a point allocation system to provide additional benefits to the user. A second payment method would be a Direct Merchant payment option, where the customers will use the Snap It Go application on their smart phones to purchase goods and services at participating locations. Merchants will pay Snap It Go a processing fee for every transaction completed. Merchants will process via their own established merchant account.

A third payment option would be a facilitator option, where the customers will use the Snap It Go application on their smart phones to purchase goods and services at participating locations. Merchants will pay Snap It Go a processing fee for every transaction completed. Snap It Go will process transactions via their own established merchant account. Another option would be a private label credit account, wherein the customers can get private credit accounts thru Snap It Go and offered by Snap It Go's Banking Partner.

Of course, any common purchase arrangement has excellent capabilities of obtaining Discount points for its customers, wherein the users collect points for amounts spent, and once points pass a certain threshold, then a discount is awarded either retroactively or proactively both with and without the user's involvement. The discount threshold and discount amount may be defined by the merchant, with the points awarded assigned by date of week and time of day.

In another embodiment, an Item count is established per user account to collect points for purchasing items, wherein points must pass a certain threshold for discount to be awarded, where again a discount threshold and discount amount is defined by the merchant. Alternatively, or concurrently, a user sign up date will be established so that one or more discounts may be awarded on the date registered by the user, where the discount amount is defined by the merchant, for example dates such as Account Anniversary, Birthday, etc. Alternatively, a merchant date discount may be established which is awarded on one or more dates registered by the Merchant, wherein the discount amount is defined by the merchant. Such example dates include Cinco de Mayo, Mother's Day, etc.

In yet another embodiment, the SIGO system is integrated into available discounts that are displayed on user interface screen via a control view, aided by Global Positioning System (GPS), Internet Protocol (IP), Cell tower and/or Wi-Fi location tools. The user selects the available discount to be used. A QR code will display and will be scanned by the merchant device upon merchant accepting the charge and validation. The token discount code will print as proof of discount and immediately removed from user available discounts. In an alternate full integration mode, a user scans a printed QR code or on-screen QR code to retrieve the transition, and available discounts will be displayed on user interface screen via a control view. The user selects the available discount to be used. The discount is applied and immediately removed from user available discounts.

Note that the transaction image/code may be scanned by more than one user, and split between them as agreed (a common group meal occurrence), and/or a user may opt to pay everything completely, thus making the person with the fastest computer the ‘winner’ of the oft repeated “I'll pay for it” race. In the above fashion, the transaction image/code may be printed on your bill, or displayed in the POS screen for acquisition by the user's device, so that a very limited timeframe may be provided, and limited ability to copy or perform other fraud activities may be allowed. Similarly, when purchasing a transaction for which additional optional gratuities may be expected, the SIGO application within the user's device may provide a space (or even suggestions of the appropriate gratuity), add these to the bill and communicate the new total to the merchant via the SIGO servers. In fact, the total AND the funds to cover it may be transferred at the same time.

In an alternate embodiment, the user (say when connectivity from their device may be limited) may accept the payment (having scanned the indicia generated by the merchant), and then proceed to have their device generate a secondary indicia (upon approval), which is then scanned by the merchant to indicate the user's approval of the transaction. Of course, such a system could be compromised (there is no direct establishment of the user's ID, just their device security), so a limit to how many of those transaction could occur could be imposed. The communication between devices using the aforementioned communication links would preferably be encrypted using industry standard protocols, ensuring that no one could replicate/duplicate the process and commit fraud.

Primary account holder can add sub accounts, sub accounts will be set up with access levels, sub accounts can have a budget set as unlimited, monthly, weekly, or daily amounts, master account will use monitoring tools to manage all its sub accounts, sub account holders will access the master account via their own devices and adhere to set budgets and access levels.

Of course, such a system as described could be confused with a credit card (minus the credit card, of course), but in fact the advantages over that are many. In one embodiment, the SIGO system proceeds to not charge either the merchant or the user a fee. Instead, the funds are separated into ‘refundable’ and ‘non-refundable’ portions. In such a case, a user depositing $100 into their SIGO account would have $97 declared as refundable, and $3 as rebates (similar to the 3% charged to merchants by CCard accounts). However, the $3 in rebates (paid for by the user effectively) are accounted as special offers that the merchant may match. In this fashion, the merchant is aware that if they make certain offers (in merchandise, say dessert for a meal), they may ‘earn’ what is today lost as commission to the CCard, at their rates.

Following the above, imagine a user deposited $100 to their SIGO account. They get dinner, where they spend $97, and are then offered coffee and dessert for $3. To the user, the meal cost $100, which they deposited to the SIGO account, so they deposited $100 and bought $100. To the merchant, they sold a dessert for $3 (which probably would not get bought otherwise), got $100 for the meal, and the dessert did not cost them $3, but most likely under $1. If the client had used their CCard, they would have gotten ‘just’ $97 for a $100 transaction, this way, they got $99!!!

In one embodiment, we see that the Snap It Go system and method does not require a secondary device to perform a transaction. It simply requires that the user have a phone with internet access and the merchant only needs to provide a QR code or other printed codes to accept payment. In this mode, the user may show a validation screen within their phone, and or have a simple text message sent to the vendor.

In one embodiment, the various Merchant provide QR codes that include; Option 1: Transaction QR, this code will include transaction amounts. A notification will be sent to the optional employee and business devices. Option 2: Employee QR, this code will reference a specific employee. The amount to pay will be selected by the user following merchant verbal or printed instructions. A notification will be sent to the optional employee and business devices. Option 3: Business QR, this code will reference the business. The amount to pay will be selected by the user following merchant verbal or printed instructions. A notification will be sent to the optional business device. Option 4: Recurring QR, User can setup via a QR code provided by the merchant a recurring payment.

Users/Customers can use the Snap It Go application to pay for goods and services at participating locations via a Snap It Go Account or directly from an electronic payment method (i.e. Credit, Debit card etc.). Similarly, the Snap It Go will create a merchant services MSP (Merchant Service Provider) and supply merchant processing services to businesses without fees. All required processing fees will be billed to the user on a per transaction basis in accordance to federal, state and local laws.

Merchants/Vendors may setup a discount method to offset processing fees automatically applied on a transaction basis. Note that Merchants are not required to open a merchant processing account with Snap It Go, they can use their existing merchant account.

As for the rewards/frequent merchant programs, the merchant will manage the rewards programs specific to their need, selecting from points, buy and get, birthday, holidays etc. applicable to an age group. Multiple programs can run at the same time. The rewards program(s) can be shared across multiple locations, including locations owned by different merchants, using a tokenized system to register under that rewards program. It is critical to understand that such a program would allow for a unified central location, where two or more separate and unrelated merchants can provide a single user the ability to collect and use rewards (discounts, coupons, receive VIP treatment), understanding that the goal is to obtain benefits without repeatedly entering endless separate programs.

In one embodiment, the Rewards Program will automatically present to the user which rewards are available, the user can select whichever discount best benefits at that transaction. In an alternate embodiment, the rewards program does allow accumulating points individually and then group those points together. Users can a transfer their earned points to other users.

Note that the Snap it Go application can manage international locations. User can pay and participate in rewards programs in different countries using the snap and go system through the same account without having to download multiple applications. Merchants can activate Tabs, allowing their customers to start a tab and registering the transaction under their account to pay later. If the transaction amount changes those changes will be reflected on their tab. If the customer leaves without paying, the merchant can send a notification and the customer can pay from anywhere at any time using their tab option.

Among the many optional embodiments, users will be able to submit gift funds to other users that are kept on a separate account. Those funds are accessible solely by receiving profile within a user account. Gifted funds can be transferred to the general user account. Merchant business geolocation from address and user device geolocation will be used to monitor transactions against fraudulent activity.

A goods and services customer review system will be available to users after they complete a transaction. Merchants will be able to reply and provide rewards and discount to the users using the review system. Posting reviews will only be available to paying customers. Reading reviews will be available to the public. Data collection will be taken from participating locations and users as to their habits of consumption. SIGO will keep track of his information and use it to create customer specific rewards, discounts and promotions.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

1. An electronic prepaid system that can be used at any participating location for paying for goods and services, said system comprising:
one or more Auto ID enabled vendor identification components;
one or more client devices having user interface display components, Auto ID scanning components and communication capabilities components;
one or more Snap It Go (SIGO) servers capable of communicating with said one or more of client devices as well as one or more merchant devices and/or merchant servers; and
one or more vendor devices capable of receiving confirmations from either said SIGO servers and/or said merchant servers and showing the SIGO approved transaction to said vendors.

2. the system of claim 1 wherein;
said one or more Auto ID enabled vendor identification component is comprised of one or more from the list consisting of: 1-D barcodes, 2-D barcodes, NFC components and/or RFID chips;
said one or more user interface component is comprised of one or more from the list consisting of: mobile Smartphone, electronic watch, tablet, laptop or similar mobile computing platform and/or fixed computing platform;
said Auto ID scanning component is comprised of one or more from the list consisting of: barcode scanner, imager scanner, NFC scanner and/or RFID scanner;
said communication capabilities component is comprised of one or more from the list consisting of: wired or wireless Internet/Ethernet, Wi-Fi and/or 3G/4G/LTE/5G or similar wireless protocol; and
said one or more vendor devices capable of receiving confirmations from either said SIGO servers and/or said merchant servers and showing the SIGO approved transaction to said vendor is comprised of one or more from the list consisting of: color light indicating approval of payment, mobile Smartphone, electronic watch, tablet, laptop, similar mobile computing platform and/or fixed computing platform.

3. An electronic prepaid method that can be used at any participating location for paying for goods and services, said method comprising:
providing one or more Auto ID enabled vendor identification components;
networking one or more client devices having user interface display components, Auto ID scanning components and communication capabilities components;
connecting one or more Snap It Go (SIGO) servers capable of communicating with said one or more of client devices as well as one or more merchant devices and/or merchant servers; and
connecting one or more vendor devices capable of receiving confirmations from either said SIGO servers and/or said merchant servers and showing the SIGO approved transaction to said vendors.

4. the method of claim 3 wherein;
said one or more Auto ID enabled vendor identification component is comprised of one or more from the list consisting of: 1-D barcodes, 2-D barcodes, NFC components and/or RFID chips;
said one or more user interface component is comprised of one or more from the list consisting of: mobile Smartphone, electronic watch, tablet, laptop or similar mobile computing platform and/or fixed computing platform;
said Auto ID scanning component is comprised of one or more from the list consisting of: barcode scanner, imager scanner, NFC scanner and/or RFID scanner;
said communication capabilities component is comprised of one or more from the list consisting of: wired or wireless Internet/Ethernet, Wi-Fi and/or 3G/4G/LTE/5G or similar wireless protocol; and
said one or more vendor devices capable of receiving confirmations from either said SIGO servers and/or said merchant servers and showing the SIGO approved transaction to said vendor is comprised of one or more from the list consisting of: color light indicating approval of payment, mobile Smartphone, electronic watch, tablet, laptop, similar mobile computing platform and/or fixed computing platform.

5. A non-transitory computer-readable medium embodying a program executable in at least one computing device, the program, when executed, causing at least one said computing device to execute a risk-sharing mechanism comprising;
one or more Auto ID enabled vendor identification components;
one or more client devices having user interface display components, Auto ID scanning components and communication capabilities components;
one or more Snap It Go (SIGO) servers capable of communicating with said one or more of client devices as well as one or more merchant devices and/or merchant servers; and
one or more vendor devices capable of receiving confirmations from either said SIGO servers and/or said merchant servers and showing the SIGO approved transaction to said vendors.

6. the method of claim 5 wherein;
said one or more Auto ID enabled vendor identification component is comprised of one or more from the list consisting of: 1-D barcodes, 2-D barcodes, NFC components and/or RFID chips;
said one or more user interface component is comprised of one or more from the list consisting of: mobile Smartphone, electronic watch, tablet, laptop or similar mobile computing platform and/or fixed computing platform;
said Auto ID scanning component is comprised of one or more from the list consisting of: barcode scanner, imager scanner, NFC scanner and/or RFID scanner;
said communication capabilities component is comprised of one or more from the list consisting of: wired or wireless Internet/Ethernet, Wi-Fi and/or 3G/4G/LTE/5G or similar wireless protocol; and
said one or more vendor devices capable of receiving confirmations from either said SIGO servers and/or said merchant servers and showing the SIGO approved transaction to said vendor is comprised of one or more from the list consisting of: color light indicating approval of payment, mobile Smartphone, electronic watch, tablet, laptop, similar mobile computing platform and/or fixed computing platform.
